(19) United States
(12) Patent Application Publication
(10) Pub. No.: US 2019/0002270 A1
(43) Pub. Date: Jan. 3, 2019

(54) EQUINE BRIDLE SYSTEM FOR PROVIDING VARIABLE PRESSURE OUTPUT RESPONSE

(71) Applicant: Marieke Gaudet, Greenland, NH (US)

(72) Inventor: Marieke Gaudet, Greenland, NH (US)

(21) Appl. No.: 16/023,217

(22) Filed: Jun. 29, 2018

Related U.S. Application Data
(60) Provisional application No. 62/528,231, filed on Jul. 3, 2017.

(51) Int. Cl. B68B 7/00; B68B 1/04

(52) U.S. Cl. CPC B68B 7/00; B68B 1/04

(57) ABSTRACT

An equine bridle system, the system having a mouth piece; a headstall; reins; and a plurality of connection interfaces being provided at opposing ends of the mouthpiece. Each connection interface is configured to resiliently deform in response to a tensile input by a user to the reins so as to provide a variable pressure output profile at the mouth piece.

### PRIORITY

This application claims priority to U.S. provisional application No. 62/528,231 which was filed on Jul. 3, 2017, which is hereby incorporated by reference in its entirety.

### COPYRIGHT STATEMENT

A portion of the disclosure of this patent application document contains material that is subject to copyright protection including the drawings. The copyright owner has no objection to the facsimile reproduction by anyone of the patent document or the patent disclosure as it appears in the Patent and Trademark Office file or records, but otherwise reserves all copyright rights whatsoever.

### BACKGROUND OF THE INVENTION

### 1. Field of the Invention

The disclosure relates to halter and bridle systems for use with equine animals, in particular horses, the halter and bridle systems connecting to the reins operated by a rider for the purpose of controlling the movements of the animal.

### 2. Description of the Prior Art

Presently in the field of horseback riding, or other equine animals, the animals have historically been controlled by utilizing a tack arrangement including a bridle and a bit. The bridle includes a headstall that extends around an upper portion of the animal's head behind the animal's ears, and reins that are held by the rider which attach about opposing sides of the bit. The bit has two main components, the mouth piece and a connection interface, the connection interface usually being provided in the form of rigid cheek rings provided about opposing distal ends of the mouth piece. The bit connects to the headstall and the reins via the side rings, and the mouth piece or pieces are placed within the animal's mouth. In this manner, force applied by pulling on the reins is transferred through the cheek rings, which causes the mouth piece of the bit to apply pressure to the animal's mouth and can thus communicate a command to the animal.

Currently, there are two main types of bits, categorized by whether or not the bit utilizes leverage through the side pieces to help control the animal. The first category are direct-pressure bits which cause the same amount of pressure applied by the rider on the reins to be applied to the animal's mouth. The second category are leverage bits, which utilize a lever or some other mechanical advantage so as to amplify the pressure applied by the rider on the reins into the mouth piece. Some bits allow for both leverage and direct pressure but require multiple sets of reins to use both functions. There are advantages for selecting the distinct types of bit depending upon the rider's preferences and the animal's temperament. The pressure realized at the bit or mouth however is always linearly associated with the rider input pressure at the reins by either by a direct transfer or a factored amplification thereof.

### SUMMARY OF THE INVENTION

The present invention provides an equine bridle system for providing variable pressure output response which allows for a dynamic pressure response at the bit in response to user input at the reins by providing a bridle system having connection interfaces, i.e. side rings, which are resilient so as to allow for variation of pressure output profile between the input at the reins and the pressure realized at the bit. In this manner, the user can be allowed to provide input in a more subtle, and in most cases non-linear pressure output profiles, in response to variations in tension applied to the reins. In some embodiments the connection interface can be configured to provide a logarithmic pressure response thus limiting the amount of pressure realized at the bit as the rider or user provides more pressure input. In some embodiments the connection interface can have an exponential initial pressure response profile which can which can reduce the amount of relative initial movement by the rider to convey a command through the reins.

As such contemplated herein is an equine bridle system, the system which can include a mouth piece or a bit; a headstall configured to extend around a portion of the animal's head and maintain relative position of the bridle system about the head of the animal; reins for receiving user input; and a plurality of connection interfaces being provided at opposing ends of the mouthpiece operatively connecting the headstall and reins to the mouthpiece. Each connection interface is configured to resiliently deform in response to a tensile input force being between zero and thirty-five pounds by a user to the reins.

In other such embodiments, the input tensile pressure applied through the reins to the plurality of connection interfaces can change the relative angle between the attachment point of the headstall on the plurality of connection interfaces with the attachment point of the mouthpiece. As the tensile pressure changes the deformation of the plurality of connection interfaces change and thus causes the relative angle between the headstall and the mouthpiece to change. This change in angle and pressure, has a varied effect on the horse.

In some embodiments the mouth piece can be connected to a forward portion of each connection interface, wherein in some such embodiments the reins can be affixed to each connection interface at a rear portion of each connection interface. Further, the headstall can be being slidingly affixed to each connection interface at an upper portion of each connection interface,

In some embodiments each connection interface can be provided as an annular ring, the annular ring being circular in an unloaded state. In some such embodiments, each annular ring can be provided with a break about the rear portion.

In some embodiments, each connection interface can be formed of a resilient thermoplastic.

In some embodiments each connection interface can be provided as a D-shaped ring, the D-shaped ring being D-shaped in an unloaded state.

In some embodiments each connection interface can be provided as a J-shaped ring, the J-shaped ring being J-shaped in an unloaded state. In some such embodiments the headstall can be affixed to the connection interface above a connection point of the mouth piece, and the mount piece is affixed between relative connection points for the headstall and the reins.

In some embodiments each connection interface can be formed having a resilient core portion being over-molded by a secondary resilient material having varying resilient properties from the resilient core.

In some embodiments a first portion of the connection interface can be formed of a rigid material, and wherein a second portion of the connection interface can be formed of a resilient material.

In some instances, each connection interface can be configured to resiliently deform through a target deformation range in response to a tensile input force ranging between 0 and 35 pounds of force, the connection interface resiliently returning to an unloaded initial shape upon release of the tensile input. Alternatively, each connection interface can be configured to resiliently deform through a target deformation range in response to a tensile input ranging between 0 and 10 pounds of force, the connection interface resiliently returning to an unloaded initial shape upon release of the tensile input.

In some alternative embodiments, the headstall, reins, and mouth piece can be rigidly affixed to each connection interface. Meanwhile, in some embodiments the headstall, reins, and mouth piece can instead be slidingly affixed about a perimeter of the connection interface.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIGS. 1A-B illustrate perspective side views of one embodiment of an equine bridle system for providing variable pressure output response in respective resting and deflected states;

FIG. 2A-B illustrate perspective side views of another embodiment of an equine bridle system for providing variable pressure output response in respective resting and deflected states;

FIGS. 3A-C illustrate side views of the equine bridle system for providing variable pressure output response of FIG. 1 in a respective resting, deflected, and overlayed state;

FIGS. 4A-C illustrate side views of another equine bridle system for providing variable pressure output response in a respective resting, deflected, and overlayed state;

FIGS. 5A-B illustrate side views of another equine bridle system for providing variable pressure output response in a respective resting and deflected state;

FIGS. 6A-B illustrate side views of yet another equine bridle system for providing variable pressure output response in a respective resting and deflected state;

FIG. 7A-B illustrate perspective cross-sectional views of an exemplary internal structure for use in any of the embodiments of the equine bridle systems for providing variable pressure output response as illustrated above; and

FIGS. 8A-C illustrate side views of various exemplary structures for use in various equine bridle systems for providing variable pressure output response as disclosed herein.

### DETAILED DESCRIPTION OF THE PREFERRED EMBODIMENT

Contemplated herein, and as illustrated in the various figures is a new and improved an equine bridle system for providing variable pressure output response for providing commands to an equine animal. It will be appreciated by those having skill in the art that various bridle systems utilize various mouth pieces or bits which extend into the animal's mouth and have a connection interface provided about opposing ends thereof. These bits are connected to at least a headstall and reins through the connection interface. Meanwhile headstall and other straps also receive some of the tensile input force at the reins and are also used to ensure proper relative positioning of the mouth piece within the mouth of the animal, the reins are utilized to receive a tensile force from a rider or user so as to transmit the tensile force into the mouth of the animal and thus convey a command.

The present invention allows for variation in the output pressure profile applied to the animal's mouth or noseband by utilizing various materials and structures as will be discussed in detail below.

Also contemplated herein is the use of the connection interface in conjunction with a bit-less bridle. Bit-less bridles utilize a nose piece instead of a bit style mouth-piece, however the mechanism is the same in that the pressure or rotation imparted to the nose piece is transferred through the connection interface to the headstall and reins.

The present invention seeks to overcome various deficiencies present in the prior art and provide a bridle and bit which can provide a wider range or bit pressure by forming the connection interface from a resilient material that will flex or elastically deform in a predetermined response profile as an increasing amount of pressure is applied to the reins. In this manner, a certain degree of variation in a predetermined profile can be achieved between the application pressure provided at the reins and headstall and that transmitted to the horse through the mouth or nose piece.

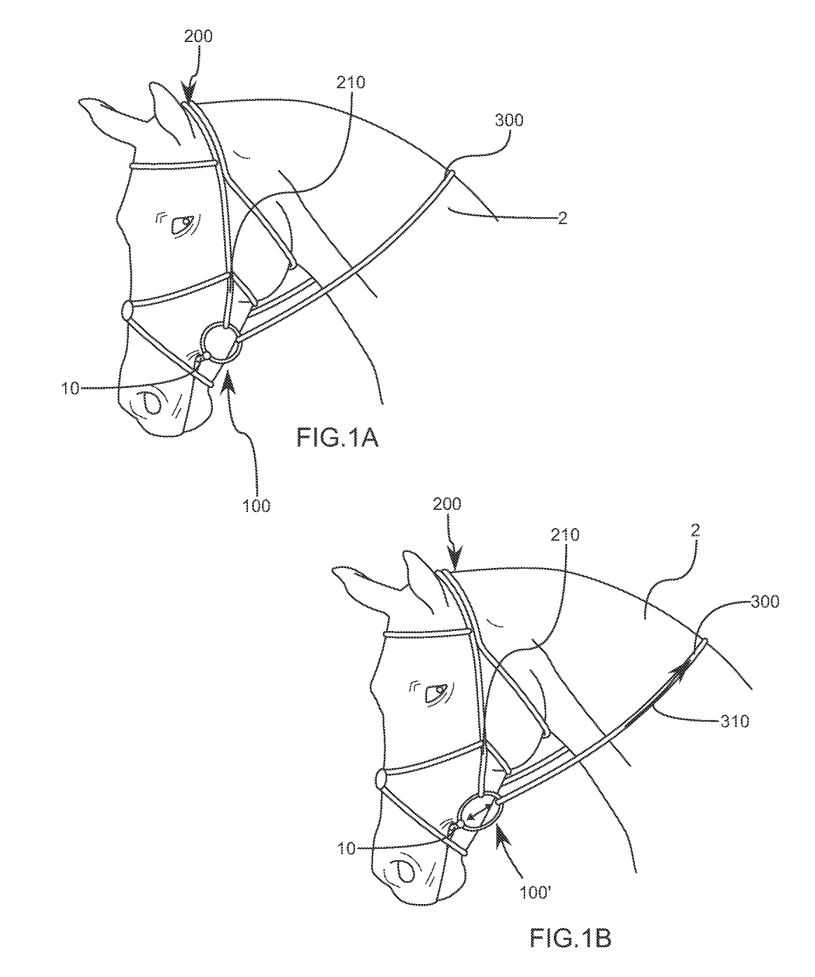

FIGS. 1A-B, and 3 illustrate an exemplary bridle system having a solid ring connection interface 100 with a mouth piece 10, headstall 200, check piece 210, and reins 300. It will be observed that FIG. 1A illustrates an unloaded or resting state and FIG. 1B illustrates a deflected state of the connection interface 100′ through the application of the tensile input force 310 to the reins 300. It will also be appreciated that the headstall 200 can include various straps or structures that extend around various portions of the head of the horse 2 so as to maintain proper relative positioning thereof. As seen in these figures, the connection interface 100 deforms in response to the tensile input force 310 into an oval or elliptical shape wherein the major radius of the ellipse extends between the reins and the mouth piece, while the minor radius compresses and pulls downward on the headstall 200.

In some instances, the connection interface can be configured to allow for deflection of the structure itself into a deformed shape, but be rigid along the axis of the material or along the circumference thereof, thus allowing deflection, but not stretching of the structure which would then result in an exponential force output profile which slowly increases in resistance or output force at low forces, but increases exponentially as more force is applied to the reins. However, in some alternative embodiments stretch or elastic deformation along the axial length or circumference can be permitted and thus allow for a logarithmic or plateaued pressure output at the bit, thus effectively limiting the amount of pressure a rider can apply to the bit. In other instances, the deformation can be designed to have a non-linear result. Which systems can be of particular advantage with use for inexperienced riders wherein such an interface can be utilized to protect the animal, particularly in instances where a rider may not understand an appropriate amount of pressure to apply.

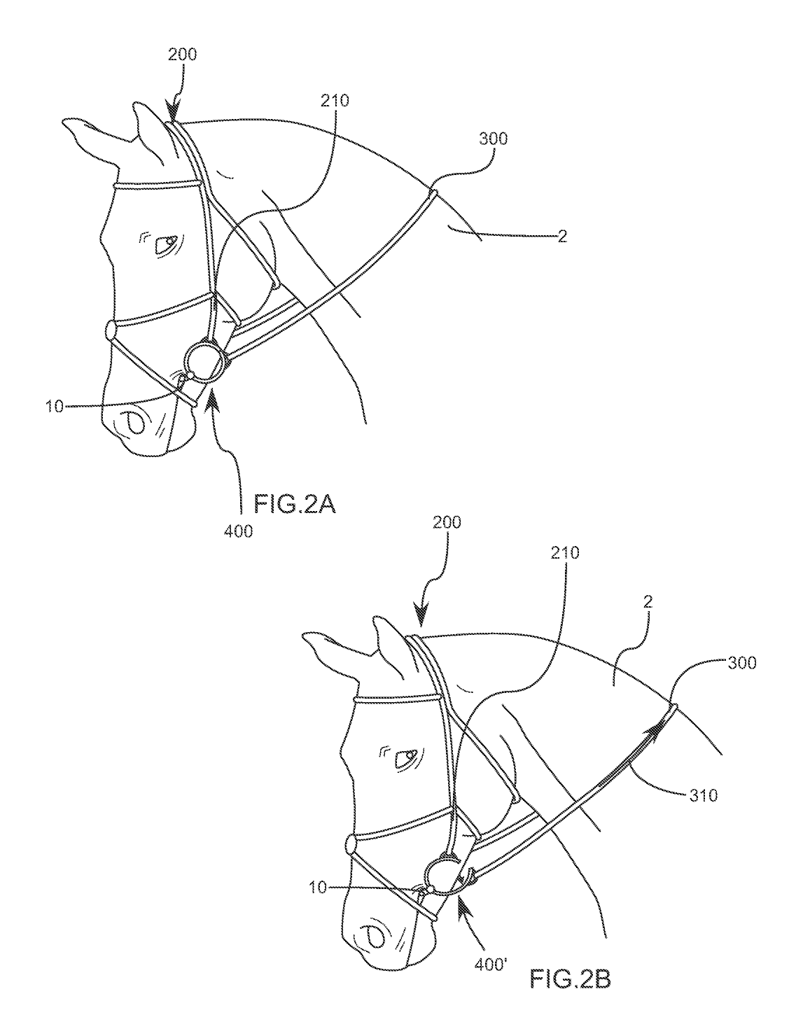

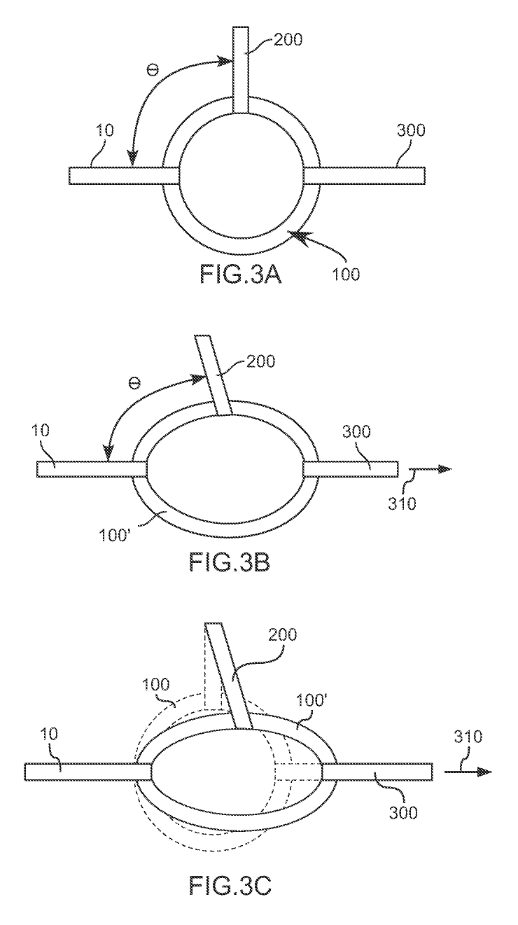

FIGS. 2A-B illustrate an exemplary bridle system having a broken ring connection interface 400 with a mouth piece 10, headstall 200, check piece 210, and reins 300. It will be observed that FIG. 2A illustrates an unloaded or resting state and FIG. 2B illustrates a deflected state of the connection interface 100 through the application of the tensile input force 310 to the reins 300. As seen in these figures, the connection interface 400 deforms in response to the tensile input force 310, as shown by 400′, thus allowing a broken rear portion 410 to extend backwards so as to easily allow initial deflection but increase in relative output as the deflection is realized and changes from a deflection to an inline pull, particularly in embodiments wherein the material selected allows for deflection but not stretch, as discussed briefly above.

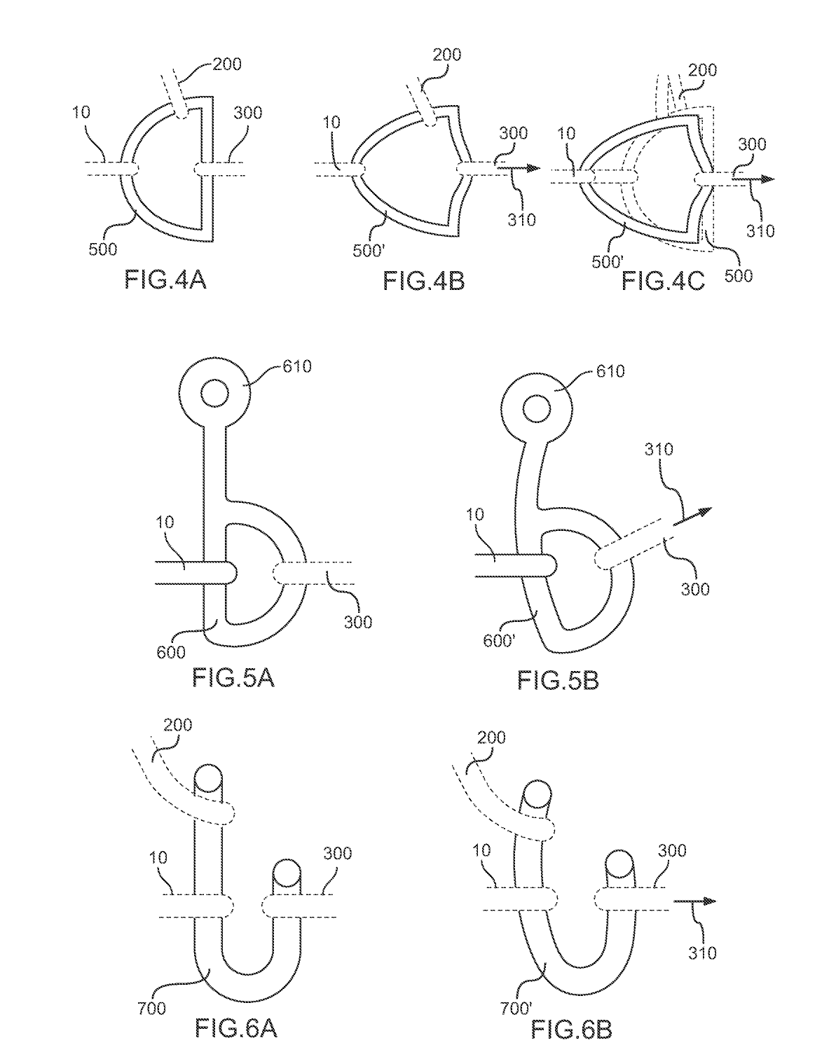

FIGS. 4-6 illustrate various additional shapes of connection interfaces which can be made with resilient materials and the shapes that may be made when the threshold of pressure is applied. While the illustrations show various types of connection interfaces having various shapes which may be used, including but not limited to O-ring, egg-butt, barrel, D-ring, snaffle, kimblewick, half-cheek, or baucher style connection interfaces wherein all or portions of the particular bit configuration can be formed of a desired resilient material so as to achieve a particular pressure response profile.

In one example embodiment of the present invention, as shown in FIGS. 4A-C, the connection interface 500 can be formed of resilient material in a D-ring shape, or such that when pressure or tensile force 310 is applied to the D-ring using the reins 300, the deformed D-ring 500′ causes a corresponding change in pressure output, as well as a corresponding change in angle between the mouthpiece or noseband 10 and headstall 200, in a predetermined pressure response profile. It will also be further appreciated that the tensile force 310 as applied to the reins 300 can also be configured to apply a varying rotational force based on the relative alignment of the tensile force 310 through the reins 300 and the attachment point of the reins and mouth piece to the connection interface 500. In other words, if the relative connection points of the reins and mouth piece are places so as to align the tensile force, little to no moment or rotational strain will be applied, meanwhile misalignment, by either placing the attachment points higher or lower than the direction of the tensile force can be caused to introduce greater or reduced rotational forces which will then be transferred into the mouth piece 10.

In this embodiment a connection ring can also be provided on an upper edge of the D-ring so as to render it into a kimblewick or snaffle shape.

In another example embodiment of the present invention, as shown in FIGS. 5A-B, the connection interface 600 can be formed of resilient material in baucher shape, such that when pressure or tensile force 310 is applied to the connection interface 600 using the reins 300, the deformed connection interface 600′ causes a corresponding change in pressure output, and in some instances angle between the mouthpiece or noseband 10 and headstall 200 which can be connected to the connection point 610, in a predetermined pressure response profile.

In yet another example embodiment of the present invention, as shown in FIGS. 6A-B, the connection interface 700 can be formed of resilient material in a J-shape, such that when pressure or tensile force 310 is applied to the connection interface 700 using the reins 300, the deformed connection interface 700′ causes a corresponding change in pressure output, as well as a corresponding change in angle between the mouthpiece or noseband 10 and headstall 200, in a predetermined pressure response profile.

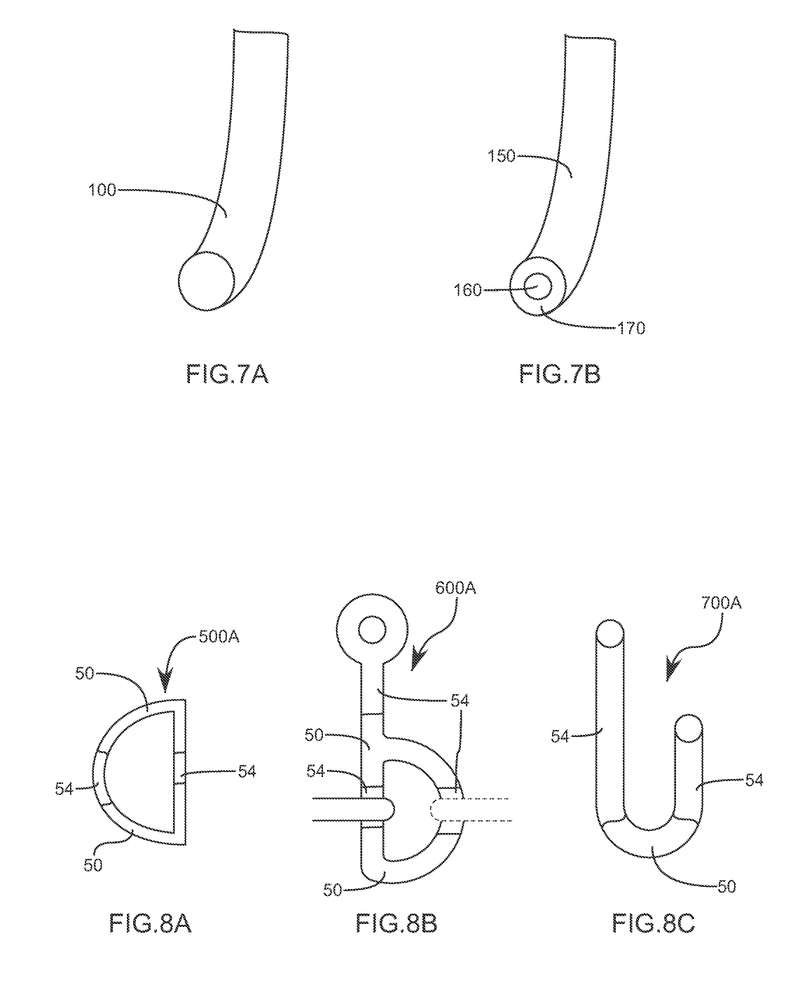

Also, as briefly discussed above, the various connection interfaces can be formed of a singular material which can be achieved by utilizing a single-shot molding process. However, in yet additional embodiments, the connection interfaces can be formed of two differing materials which can be achieved by utilizing a double-shot molding process, wherein a resilient material is over-molded onto a differing material. For example, and as shown in FIG. 7b, an inner core 160 could be provided having an over-molded casing 170 molded or otherwise formed thereover. Such embodiments may be utilized so as to provide a desired resilience profile wherein the outer casing 170 provides certain pressure output profiles, for example, a resilient thermoplastic could be over-molded onto a spring steel core, or a woven fiber or cable core. In which case, the woven fiber core could resist axial stretching while the exterior casing 170 provides the desired deflection profile or properties.

Additionally, in some embodiments of the present invention, and as illustrated above, the connection interface can be wholly made of a singular or unitary resilient material. However, in other embodiments, and as illustrated in FIGS. 8A-C the various connection interfaces 500A, 600A, or 700A can be made of inflexible portions 54 being formed of an inflexible material with various flexible portions 50 being formed of a resilient material so as to allow desired deformation or deflection in desired areas.

It will also be understood that in some instances certain advantages and pressure profiles can be recognized by providing secure or fixed connection locations between the reins, headstall, or mouth piece to any particular connection interface. In some instances, desired pressure profiles can be achieved by providing slidable or translating connection interfaces as various combinations may allow for variation in the alignment of the tensile force applied to the reins and the pressure output provided to the mouth piece, or the change in relative angle between the headstall and the noseband or mouth piece.

The materials that comprise the resilient connection interfaces discussed herein are advantageously designed to withstand variable, and often unpredictable, long term forces such as: heat, cold, UV exposure, animal misbehavior, etc. The total flexure cycles experienced over the lifetime of the ring could number well over 1,000,000, and thus must be able to withstand flexure cycles while exposed to environmental factors. As such, various materials can be used which can withstand such flexure cycling such as thermoplastic polyurethane, synthetic rubbers, polyamides, carbon fiber or other reinforcement structures as well as other engineered plastics and composites can also be utilized.

As discussed above, the resilient connection interfaces can be fabricated utilizing a resilient core having alternative properties from an exterior over-molded portion. For example, a resilient spring steel overlaid by engineered plastics. Or the entire connecteion interface can be entirely formed of a singular material, for example engineered plastic type materials.

In some embodiments, it can be advantageous to form the structures from medical grade or food-grade plastics, as the product will be utilized adjacent to the horse's open mouth. However, food-grade may not be necessary to achieve the desired pressure output profile, and in some instances, depending on the connection with the mouth or nose piece the connection interfaces may not necessarily come into contact with the horse's mouth.

Some exemplary engineered plastics or materials for forming the connection interfaces can include: Polyamide (66), such as Ultramide A3H™, Polyamide (12), such as Vestamid ML16™, which comply with USP class VI and ISO 10993 standards, TPE such as Medalist MD-12342™, Santoprene 101-55™ TPV/TPE family, Polyether block amides (PeBA) such as Vestamid™, and Polyester, or thermoplastic polyurethane, such as Texin 255™.

In some embodiments, the process for manufacturing the connection interfaces can include an injection molding process which can utilize raw plastic material in bead form melted then injected into a metal mold. In the prior art, standard loose ring bits have the rings welded onto the mouthpiece. In contrast, the resilient connection interfaces described herein can be molded in a two-stage injection process so as to retain the mouthpiece integrity but it may also be possible to utilize O-ring technology to create the connection interface structure, then create a special attachment onto the bit such that the connection interface can then be affixed to the mouthpiece.

In the case a different material is utilized at the core of the connection interface, an over-molding process can used with the same tool fitted with a special stabilizer to keep the core centered as the plastic is injected around it within the injection mold.

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention.

Further, while certain features are discussed in relation to various figures or embodiments, it should be appreciated that those having skill in the art will be able to take features and advantages discussed in relation to any single embodiment disclosed herein and apply the same principles in any combination to any one of the other embodiments, as appropriate, disclosed herein.

1. An equine bridle system, the system comprising:
a mouth piece;
a headstall;
reins; and
a plurality of connection interfaces being provided at opposing ends of the mouthpiece, wherein the mouth piece is connected to a forward portion of each connection interface, the reins being affixed to each connection interface at a rear portion of each connection interface, and the headstall being affixed to each connection interface at an upper portion of each connection interface, wherein each connection interface is configured to resiliently deform in response to a tensile input force being between zero and thirty-five pounds by a user to the reins.

2. The equine bridle system of claim 1, wherein each connection interface is an annular ring, the annular ring being circular in an unloaded state.

3. The equine bridle system of claim 2, wherein each connection interface is formed of a resilient thermoplastic.

4. The equine bridle system of claim 1, wherein each connection interface is an annular ring, each annular ring having a break about the rear portion.

5. The equine bridle system of claim 1, wherein each connection interface is a D-shaped ring, the D-shaped ring being D-shaped in an unloaded state.

6. The equine bridle system of claim 1, wherein each connection interface is a J-shaped ring, each J-shaped ring being J-shaped in an unloaded state.

7. The equine bridle system of claim 6, wherein the headstall is affixed to each connection interface above a connection point of the mouth piece, and the mount piece is affixed between relative connection points for the headstall and the reins.

8. The equine bridle system of claim 1, wherein each connection interface is formed having a resilient core portion being over-molded by a secondary resilient material having varying resilient properties from the resilient core.

9. The equine bridle system of claim 1, wherein a first portion of the connection interface is formed of a rigid material, and wherein a second portion of the connection interface is formed of a resilient material.

10. The equine bridle system of claim 1, wherein the connection interface is configured to resiliently deform through a target deformation range in response to a tensile input force ranging between 0 and 35 pounds of force, the connection interface resiliently returning to an unloaded initial shape upon release of the tensile input.

11. The equine bridle system of claim 1, wherein the tensile input force applied to the plurality of connection interfaces results in a change to a relative angle between the mouth piece and the headstall.

12. The equine bridle system of claim 1, wherein the headstall, reins, and mouth piece are rigidly affixed to the connection interface.

13. The equine bridle system of claim 1, wherein the headstall, reins, and mouth piece are slidingly affixed about a perimeter of the connection interface.

14. The equine bridle system of claim 1, wherein the tensile input force applied to the plurality of connection interfaces results in a non-linear output force directed to the mouth piece

15. An equine bridle system, the system comprising:
a mouth piece;
a headstall;
reins;
a plurality of connection interfaces being provided at opposing ends of the mouthpiece, wherein each connection interface is provided as an annular ring, the annular ring being circular in an unloaded state, wherein the mouth piece is slidingly connected to a forward portion of each connection interface, the reins being affixed to each connection interface at a rear portion of each connection interface, and the headstall being slidingly affixed to each connection interface at an upper portion of each connection interface, wherein each connection interface is configured to resiliently deform in response to a tensile input force being between zero and thirty-five pounds by a user to the reins.

16. The equine bridle system of claim 15, wherein each connection interface is formed of a resilient thermoplastic.

17. An equine bridle system, the system comprising:
a mouth piece;
a headstall;
a plurality of connection interfaces being provided at opposing ends of the mouthpiece, wherein each connection interface is provided as an annular ring, the annular ring being circular in an unloaded state, wherein each connection interface being affixed to the mouth piece at a forward portion of the connection interface, and
wherein a tensile force applied to the plurality of connection interfaces results in a non-linear output force directed to the mouth piece.

18. The equine bridle system of claim 17, further comprising:
a rein connection interface provided about a rear portion of the connection interface.

19. The equine bridle system of claim 18, wherein each connection interface is configured to resiliently deform in response to a tensile input force being between zero and thirty-five pounds at the rein connection interface.

20. The equine bridle system of claim 17, wherein the connection interface is formed of a resilient thermoplastic.
